(19) United States
(12) Patent Application Publication
(10) Pub. No.: US 2009/0266822 A1
(43) Pub. Date: Oct. 29, 2009

(54) Painting apparatus

(76) Inventor: OVY RANKINS, Carson, CA (US)

Correspondence Address: Law Office of Michael N. Cohen, P.C., 9025 Wilshire Blvd., Suite 301, Beverly Hills, CA, 90211, US

(21) Appl. No.: 12/111,656

(22) Filed: Apr. 29, 2008

(51) Int. Cl. B05C 21/00; B65D 25/00

(52) U.S. Cl. 220/570; 220/694

(57) ABSTRACT

A painting apparatus and method for creating a moist environment to prevent the paint from hardening is disclosed. The apparatus and method includes an enclosure with a pool for liquid on the bottom surface, a frame above the enclosure and a plastic bag or other materials to cover the apparatus. A painting tray is inserted into the painting apparatus just above the pool of liquid in the enclosure and the plastic bag is placed above the frame enveloping the entire apparatus. Moisture drawn from the water keeps the paint fresh and prevents it from hardening. The plastic bag or other covering material in locked condition retains the moisture and prevents the moisture from escaping and keeps the paint in the paint tray fresh for an extended period of time.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to a painting apparatus, and more particularly to a paint tray assembly for creating a moist environment to prevent the paint from hardening.

### DISCUSSION OF RELATED ART

While painting a building or house, more than one device is typically used for applying paint. Painting equipment used by painters mostly consists of a roller assembly and a paint tray. A batch of paint from a convenient sized container of paint is poured into a tray that usually has a storage capacity considerably less than the volume of paint container for the ease of the painters. The roller sleeve is dipped into the tray as the work progresses until the batch is exhausted, at which time another batch is poured into the tray.

There are possibilities that the painting job may be interrupted before the painting is complete. If the paint is left open in the tray, a skin may form on the surface of the paint and the paint applicator may harden due to solvent evaporation. When the user resumes painting, the user has the option of throwing out or cleaning the roller sleeve and pouring the unused paint back into the original container. However, it is invariably a time consuming process. Further, the solvent evaporation makes the paint thicker thus reducing the surface covering ability and quality of the paint.

Typically, when painting, the paint must be continuously stirred to keep the paint fresh and to prevent hardening. Leaving the paint trays to open air for a period of time causes stiffening of the paint and the paint adheres to the paint roller assembly. In such situations, the painter should clean the painting apparatus and make it ready for use when he resumes painting.

There are some methods by which the paint can be retained fresh for a period of time. The paint roller tray containing the paint is slid into a plastic bag or the like and the bag is sealed so that the paint does not dry out rapidly. The paint brushes or related items are generally immersed in a liquid to prevent hardening of paint on them. The liquid has to be dried off before reusing the brush or related item. Moreover, if the brush or related item is immersed in the liquid for a longer period, the liquid may evaporate causing hardening of the brush or paint applying portion of the item. Some paint roller trays have closely fitting reusable lid which may help the paint from drying, but for a short period of time.

Therefore, there is a need for a painting assembly that prevents the paint from hardening for an extended period of time. There is also a need for a painting assembly that includes an enclosure for creating a moist environment to resist the paint from hardening. Additionally, such painting assembly should comprise a material covering that prevents the moisture from escaping. The present invention accomplishes these objectives.

### SUMMARY OF THE INVENTION

The present invention is a painting apparatus for creating a moist environment to prevent the paint from hardening. The apparatus includes an enclosure having a pool for water and/or liquid at the bottom surface, a frame above the enclosure and a plastic bag or other material covering to envelope the entire painting apparatus.

The liquid is poured into the pool at the bottom of the enclosure to provide a moist environment to the paint. The paint tray containing the paint is inserted into the painting apparatus and is placed just above the pool of liquid. The moisture drawn from the liquid prevents the paint retained in the roller and in the paint tray from hardening.

The painting tray is placed above the pool of liquid and the entire apparatus is covered by a plastic bag or such material. The plastic bag envelops the entire apparatus, retains the moisture, and prevents the moisture from escaping. The plastic bag and/or material covering can be closed or locked to retain the moisture drawn from the liquid thereby keeping the paint fresh and can prevent the paint from hardening. The locked condition of the bag retains the moisture so that the user can leave the paint over a period of time without drying.

In one aspect of the invention, the frame above the enclosure of the painting apparatus avoids the contact between the plastic bag and the paint left in the tray when the plastic bag is in closed condition. The frame is positioned in a way such that the plastic bag will not overlap with the paint left in the tray and the painting roller.

The foregoing enumeration of embodiments has been for illustrative purposes only. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a painting apparatus for creating a moist environment to prevent the paint from hardening.

FIG. 2 is another perspective view of the invention, illustrating an enclosure, a frame and a paint tray.

FIG. 3 is a perspective view of the invention, illustrating a plastic bag enveloping the entire painting apparatus.

FIG. 4 is a high level flow diagram illustrating a method for preventing the paint from hardening,

### DETAILED DESCRIPTION OF THE PREFERRED EMBODIMENT

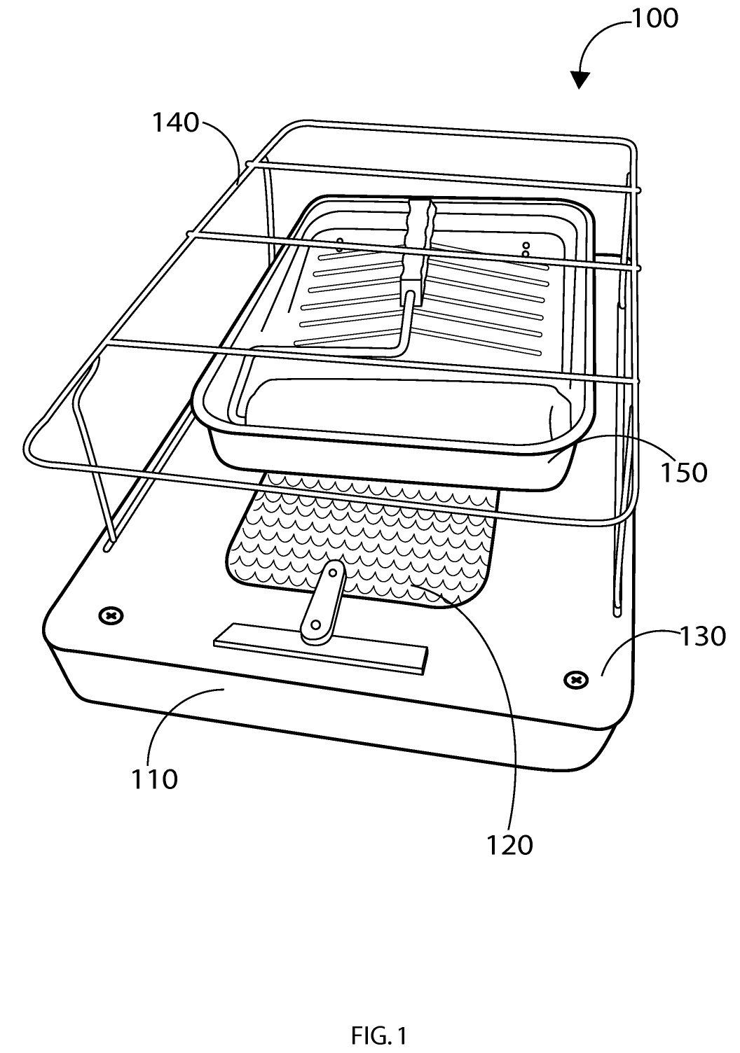

Referring to FIG. 1, illustrated is a painting apparatus 100 for creating a moist environment to prevent the paint (not shown) from hardening. The apparatus 100 includes an enclosure 110 with a pool 120 for a liquid at the bottom surface 130 and frame 140 above the enclosure 110. The liquid at the bottom surface 140 of the enclosure 110 create a moist environment to painting apparatus 100, thereby preventing the paint in the paint tray 150 from hardening.

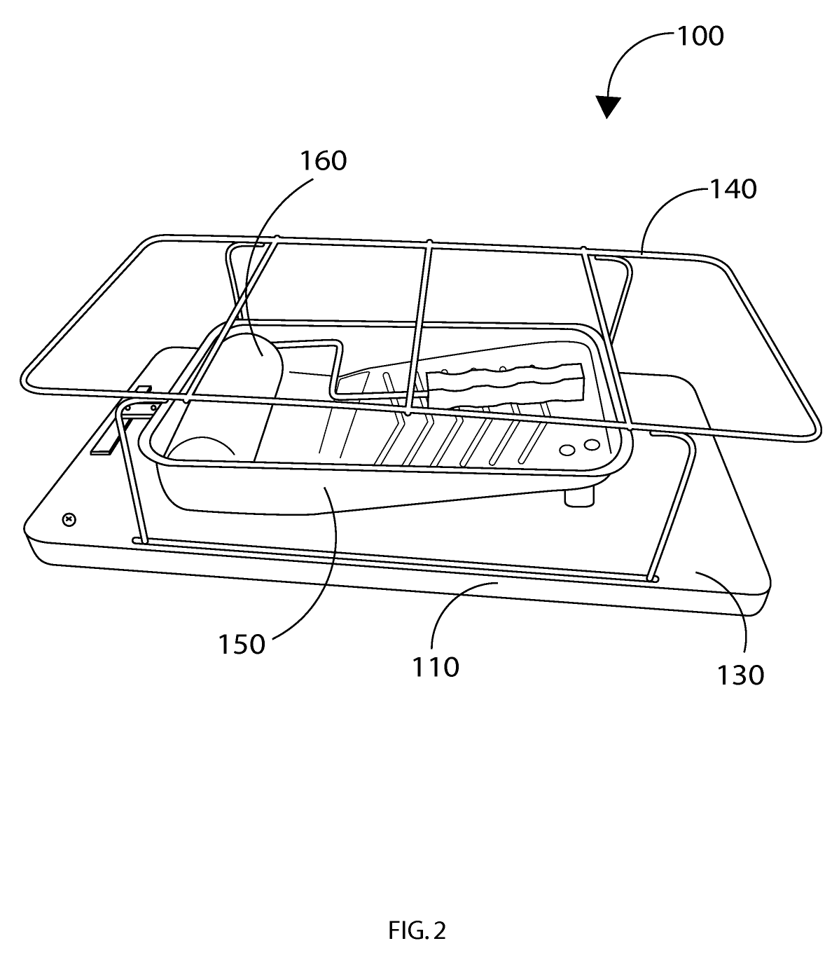

Referring to FIG. 2, illustrates the paint tray 150 inserted into the painting apparatus 100. The paint tray 150 is placed above the pool 120 of liquid at the bottom surface 130 of the enclosure 110, thereby drawing moisture from the liquid to keep the paint fresh. A frame 140 is positioned above the enclosure 110. The illustration further displays a paint roller 160 kept on the paint tray 150.

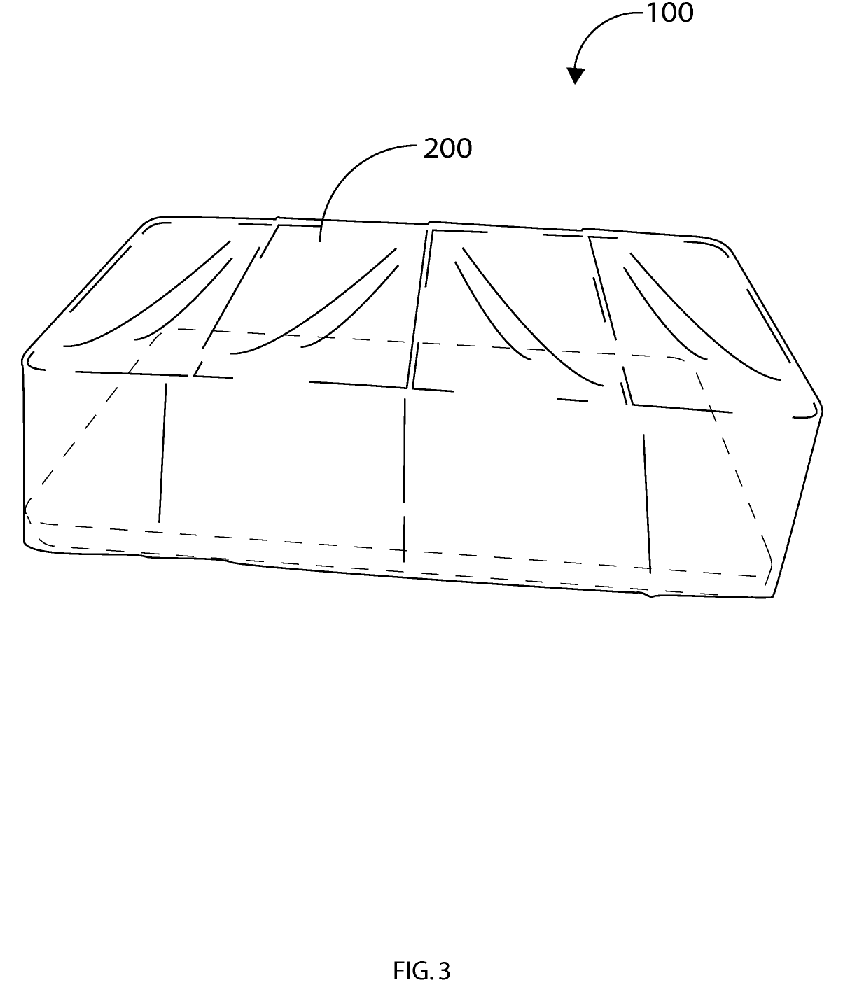

Referring to FIG. 3 is a perspective view of the invention, illustrating a plastic bag 200 enveloping the entire painting apparatus 100. The plastic bag 200 retains the moisture drawn from the liquid and keeps the paint (not shown) fresh and prevents it from hardening. The painting tray 150 is inserted into plastic bag 200 and the user closes or locks the plastic bag 200 to retain the moisture drawn from the liquid. The frame 140 above the enclosure 110 avoids the contact between the plastic bag 200 and the paint in the tray 150. The plastic bag 200 retained in the locked condition prevents the moisture form escaping and keeps the paint fresh for an extended period of time.

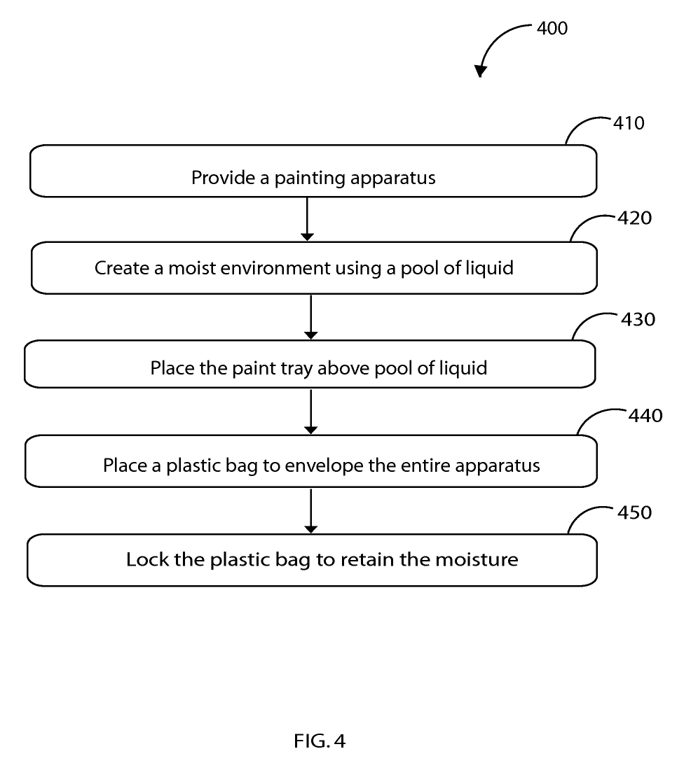

Referring to FIG. 4 is a high level flow diagram illustrating a method 400 for preventing the paint contained in paint tray from hardening. As indicated by block 410, a painting apparatus is provided that includes an enclosure having a pool for liquid at the bottom surface, a frame, and a plastic bag. Next, as described at block 420, a moist environment is created to the painting apparatus by pouring water into the pool at the bottom surface of the enclosure. Thereafter, as depicted at block 430, moisture is drawn from liquid by placing the paint tray is placed above the pool of liquid. Next, as indicated at block 440, a plastic bag placed above the frame envelops the entire apparatus. Thereafter, as described at block 450, the plastic bag is locked for retaining the moisture within the apparatus to prevent the paint from hardening.

As the paint tray 150 is inserted into plastic bag 200, the user may close or lock the plastic bag 200. The plastic bag 200 above the frame 140 completely seals off the interior space defined within the paint roller tray 150 and the enclosure 110. In this condition, the moisture created by pool 120 of liquid soon fills the entire volume of the painting apparatus 100 and the plastic bag 200 that envelops the entire apparatus 100, thereby retaining the moisture and prevents the moisture from escaping.

While a particular form of the invention has been illustrated and described, it will be apparent that various modifications can be made without departing from the spirit and scope of the invention. For example, the painting apparatus can be manufactured by different styles including different plastic cover model, different enclosure model, locking method, providing some type of liquid to draw moisture from the liquid to keep the paint fresh. Accordingly, it is not intended that the invention be limited, except as by the appended claims.

What is claimed is:

1. A painting apparatus to create a moist environment for preventing the paint from hardening, comprising:
an enclosure having a pool for liquid on the bottom surface;
a frame above the enclosure;
at least a plastic bag; and
a paint tray for storing the paint.

2. The apparatus of claim 1, wherein the paint tray is inserted inside the painting apparatus, thereby placing the paint tray above the pool of liquid.

3. The apparatus of claim 1, wherein the pool of liquid on bottom surface of the enclosure creates a moist environment for the paint.

4. The apparatus of claim 1, wherein at least a plastic bag is placed above the frame, thereby enveloping the entire apparatus.

5. The apparatus of claim 1, wherein the plastic bag or cover covering material is locked after placing the paint tray in the apparatus.

6. The apparatus of claim 1, wherein the plastic bag retains the moisture drawn from the liquid and prevents the moisture from escaping, thereby preventing the paint from hardening.

7. The apparatus of claim 1, wherein the frame above the enclosure of the painting apparatus avoids the contact between the plastic bag and the paint left in the tray when the plastic bag is in closed condition.

8. The apparatus of claim 1, wherein the position of the frame avoids the overlap of plastic bag with the paint left in the tray and in the painting roller.

9. A method for preventing the paint from hardening by creating a moist environment, the method comprising;
providing an enclosure with a pool for a liquid on the bottom surface and a frame above the enclosure;
providing a paint tray;
providing at least a plastic bag and material covering for enveloping the entire apparatus.

10. The method of claim 9, wherein a liquid is poured into the pool to provide moisture for keeping the paint fresh.

11. The method of claim 9, wherein the paint tray is inserted inside the painting apparatus, thereby placing the paint tray above the pool of liquid.

12. The method of claim 9, wherein the plastic bag or cover covering material is locked after placing the paint tray in the apparatus.

13. The method of claim 9, wherein the plastic bag retains the moisture drawn from the liquid and prevents the moisture from escaping, thereby preventing the paint from hardening.

14. The method of claim 9, wherein positioning of the frame avoids overlapping of plastic bag with the paint left in the tray and in the painting roller.
